(19) United States
(12) Patent Application Publication
(10) Pub. No.: US 2002/0036273 A1
(43) Pub. Date: Mar. 28, 2002

(54) Methods for manufacturing reticles for charged-particle-beam microlithography exhibiting reduced proximity effects, and reticles produced using same

(75) Inventor: Teruaki Okino, Kamakura-shi (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 09/942,856

(22) Filed: Aug. 29, 2001

(30) Foreign Application Priority Data
Aug. 29, 2000 (JP) 2000-258612

(51) Int. Cl. G01J 1/00; G01N 21/00; G01N 23/00

(52) U.S. Cl. 250/491.1

(57) ABSTRACT

Methods are disclosed for producing reticles for use in charged-particle-beam microlithography. In an exemplary method, a pattern to be formed on a sensitive substrate is designed. For at least certain of the pattern elements, local resizing is determined as appropriate for correcting proximity effects. Corresponding “initial value” reticle-pattern data is then produced. During drawing of the reticle pattern on a reticle substrate using an electron beam, the beam dose is varied so as to change linewidths of the pattern elements from their respective initial value data. Drawn linewidths also can be changed for pattern elements during drawing. The reticle that is produced exhibits better correction of proximity effects when the pattern is transferred to the sensitive substrate.

### TECHNOLOGICAL FIELD

This disclosure pertains to microlithography, which involves the transfer of a pattern, usually defined by a reticle or mask, to the surface of a substrate using an energy beam. For receiving the transferred image, the substrate surface is made “sensitive,” by application of a material termed a “resist,” to exposure by the energy beam. Microlithography is a key technology used in the manufacture of microelectronic devices such as integrated circuits, displays, thin-film magnetic heads, and micro-machines. More specifically, the disclosure pertains to microlithography in which the energy beam is a charged particle beam such as an electron beam or ion beam, and to reticles used in charged-particle-beam microlithography.

### BACKGROUND

The degree of integration in semiconductor integrated circuits has risen steadily in recent years, accompanied by corresponding increases in the density (number of electronic devices such as transistors per unit area) of circuit patterns. Hence, the required accuracy and precision of inter-layer alignment and registration are increasing progressively.

Fabrication processes for making modern integrated circuits and related devices have become extremely complex, and typically involve multiple microlithography steps. Most conventional microlithography is performed using “optical stepper” machines. These machines are termed “optical” steppers because the lithographic energy beam is within the range of “optical” wavelengths (typically deep ultraviolet) of electromagnetic radiation. The machines are termed “steppers” because of their tendency to perform exposure by a “step-and-repeat” exposure scheme. In step-and-repeat exposure in optical microlithography, multiple devices (“dies” or “chips”) are formed on a single wafer, and exposure proceeds from one device to the next, or at least from one exposure unit to the next within a single die, in a step-wise manner.

For optical microlithography, the pattern is defined by a reticle or mask (generally termed a “reticle” herein). The pattern normally is formed on the reticle by inscription using an electron beam.

The degree of miniaturization of microelectronic devices has progressed to the point that optical microlithography is increasingly unable to resolve the extremely small circuit elements of the devices. In other words, optical microlithography currently is being operated at the diffraction limit of the wavelength of the energy beam, which prevents resolution of increasingly smaller pattern elements using the particular energy beam. Hence, a great effort is ongoing to develop the “next-generation” microlithography technology intended to succeed optical microlithography.

One candidate next-generation microlithography technology is based upon using a charged particle beam, such as an electron beam, as the energy beam. Charged-particle-beam (CPB) microlithography offers prospects of increased pattern resolution for reasons similar to reasons for which electron microscopy achieves much better image resolution than optical microscopy. Whereas electron-beam direct-writing lithography commonly is used to form patterns on reticles used in optical microlithography steppers, a practical CPB microlithography technology has not yet been developed for use in the mass-production of microelectronic devices.

Within the realm of CPB microlithography, various approaches have been investigated. One approach involves inscribing the pattern element-by-element by electron-beam writing, similar to the manner in which most reticles conventionally are produced. However, a serious drawback of this approach for large-scale fabrication of microelectronic devices is that its “throughput” (number of wafers that can be processed per unit time) is extremely low. Other approaches achieve better throughput, but all have respective throughputs that are lower than currently achievable using optical microlithography.

For example, in the approach variously termed “cell projection,” “character projection,” or “block exposure,” a highly repeated (but very small, about 5-μm square on the substrate) fundamental graphic unit of the pattern is exposed repeatedly to form a part of the overall pattern made up of the highly repeated portions. The fundamental unit is defined, typically many times, on a reticle. During exposure, one of the units on the reticle is selected for exposure at a given instant; as exposure progresses, different units on the reticle are selected so as to avoid over-heating or over-using any single unit. This approach has been used for fabricating memory chips and the like, wherein the highly repeated graphic unit is a memory cell or portion thereof. One disadvantage of this approach is that portions of the overall pattern not comprised of the highly repeated graphic units must be exposed using another technique such as use of a variable-shaped beam. The need to utilize multiple techniques to achieve exposure of the complete pattern reduces overall throughput.

A CPB microlithography approach that offers tantalizing prospects of vastly increased throughput involves exposing an entire die pattern simultaneously, similar to what is done in optical microlithography. According to this approach, the entire die pattern is defined on a reticle and is projection-exposed, usually with demagnification, onto the surface of the substrate using an electron beam. Unfortunately, it has been impossible to date to expose an entire pattern in one “shot” using an electron beam. First, making a reticle suitable for one-shot whole-reticle exposure is impossible using current technology. Second, the electron optics must be extremely large to expose a field sufficiently large to encompass an entire reticle; such optical systems are prohibitively expensive to manufacture and operate. Third, with electron-optical systems having large fields, it currently is impossible to control aberrations, especially off-axis aberrations, adequately for yielding acceptable lithography results.

Another CPB microlithography approach offers the best current prospects for commercial practicality. This approach, termed “divided-reticle” projection microlithography, has received considerable recent attention. It involves dividing a die pattern, as defined on the reticle, into multiple respective subunits (usually termed “subfields”) that are exposed individually. The CPB optical system employed has a large optical field, but not as large as would be required for one-shot whole-reticle exposure. Thus, the optical system need not have as large a field as required for one-shot whole-reticle exposure. As exposure of the die progresses, corrections can be made in real time of certain aberrations and distortions in the optical field and/or of the respective focal points of the subfield images. The respective subfield images are positioned on the substrate such that they are “stitched” together properly to create the entire pattern on the substrate in each die. Divided-reticle exposure can be performed with excellent resolution and precision over a much larger optical field than achievable using full-pattern single-shot exposure.

Whenever a resist-coated semiconductor wafer or other sensitive substrate is exposed using a charged particle beam, a phenomenon termed a “proximity effect” unfortunately occurs. The proximity effect occurs by exposure of regions, adjacent intended pattern elements as projected onto the substrate, by electrons backscattered from the substrate. In other words, electrons generated from impingement of the charged particles of the beam on the surface of the substrate spread out as they scatter, which imparts exposure energy to adjacent regions of resist not intended to receive any exposure energy. As a result, the adjacent regions are exposed at least partially, which results in deformation and loss of resolution of pattern elements as imaged on the resist. The magnitude and specific manifestation of the proximity effect on a projected pattern element depend upon the distribution of nearby pattern elements.

A common manifestation of the proximity effect is an error in the linewidth of a pattern element as formed on the substrate. One way in which to correct this error (and thus restore the imaged pattern element to its desired linewidth dimensions and profile) is to alter the dimensions and profile of corresponding pattern elements as defined on the reticle. This “local resizing” of pattern elements on the reticle involve extensive proximity-effect-correction calculations to produce pattern elements that, when projected onto the substrate, are as close as possible to their respective desired configurations.

However, with the progressive increase in accuracy required for reticles capable of producing increasingly fine patterns on wafers, enormous demands have been imposed on reticle-drawing apparatus and methods. For example, for use with a microlithography apparatus having a 1/4 demagnification ratio, the reticle needs an “address unit” (i.e., the smallest unit of position on the reticle) of about 1 nm. This means that the reticle-drawing apparatus must be capable of resolving an address unit of approximately 1 nm. In other words, the unit of data for reticle drawing is 1 nm. If a reticle-drawing apparatus has an address unit of 1 nm, then the bit length of digital-to-analog converters (DACs) controlling the beam deflector used for reticle drawing must be correspondingly greater, which substantially increases equipment cost.

Another disadvantage of this situation is that it prevents shortening the statistically significant time required for drawing the reticle. I.e., if the unit of data for reticle drawing is 1 nm, then an enormous amount of data is required for reticle drawing, with a corresponding increase in data-processing time. Also, more memory capacity is needed for storing and manipulating the data, which also increases cost.

### SUMMARY

In view of the shortcomings summarized above, an object of the instant claims is to provide improved methods for reducing proximity effects in charged-particle-beam microlithography, and for manufacturing reticles for the same.

To such end, proximity-effect correction methods are provided. The methods are set forth in the context of a charged-particle-beam (CPB) microlithography method. In the CPB microlithography method, a device pattern, to be transferred onto a specific area of a sensitive substrate, is defined on a reticle. The reticle is subsequently illuminated with a charged-particle illumination beam to form a patterned beam that is directed at the sensitive substrate so as to imprint a corresponding region of the substrate with the pattern. In this context the subject methods are directed to correcting errors in pattern elements, as imprinted on the substrate, caused by proximity effects.

According to an embodiment of the proximity-effect correction method, in performing a local resizing of a pattern element on the reticle, a linewidth of the pattern element, as defined on the reticle, is changed. The linewidth change is made by correspondingly changing an energy dose of an electron beam used to draw the pattern element on the reticle so as to change the linewidth from its initial design value.

According to another embodiment of the proximity-effect correction method, in performing a local resizing of a pattern element on the reticle, a linewidth of the pattern element, as defined on the reticle, is changed. The linewidth change is made by correspondingly changing: (1) a drawn linewidth of the pattern element, and (2) an energy dose of an electron beam used to draw the pattern element on the reticle so as to change the linewidth from its initial design value.

Also provided are methods for producing a reticle for use in transferring a pattern, defined by the reticle, from the reticle to a substrate by charged-particle-beam microlithography. According to an embodiment of such a method, in a design for a reticle pattern comprising pattern elements to be transferred to the substrate, calculations are made of local-resizing corrections to profiles of the pattern elements, to be defined on the reticle. The calculations are made so as to configure the pattern-element profiles for correcting proximity effects that otherwise would be manifest on the pattern elements when projected onto the substrate. From the calculated corrections, corrected reticle-pattern data are obtained. The pattern elements are formed on a reticle by drawing the pattern elements using an electron beam that is variably shaped as required to impart respective changes, according to the corrected reticle-pattern data, in a dose of the electron beam on the reticle. The changes in dose impart corresponding changes in linewidths of the pattern elements, as defined on the reticle, sufficiently to reduce proximity effects acting on the pattern elements when the pattern is transferred to the substrate. These methods can include the step, when forming the pattern elements on the reticle, of changing the drawn line width of the pattern elements.

In another embodiment of the methods for producing a reticle, profile-correction calculations are made, as noted above, to obtain corrected reticle-pattern data. Local resizing is performed according to these data. The locally resized pattern elements are formed on a reticle by drawing the pattern elements using an electron beam to impart respective changes, according to the corrected reticle-pattern data, in a dose of the electron beam on the reticle. The changes in dose impart corresponding changes in linewidths of the locally resized pattern elements, as defined on the reticle, sufficiently to reduce proximity effects acting on the pattern elements when the pattern is transferred to the substrate. These methods can include the step, when forming the pattern elements on the reticle, of changing the drawn linewidth of the pattern elements.

Also provided are reticles produced according to any of the subject methods.

Also provided are reticles that comprise a reticle substrate and a pattern defined on the reticle substrate. The pattern includes one or more pattern elements that are locally resized relative to respective design specifications for the pattern elements. Each locally resized pattern element has a respective linewidth that is corrected so as to reduce a proximity effect that otherwise would occur if the pattern element were exposed onto a sensitive substrate without the corrected linewidth. The linewidth is corrected on the reticle by varying a dose of an electron beam used to write the pattern element on the reticle substrate. The respective linewidths of the pattern elements as drawn on the reticle substrate also can be changed.

The foregoing and additional features and advantages of the invention will be more readily apparent from the following detailed description, which proceeds with reference to the accompanying drawings.

### BRIEF DESCRIPTION OF THE DRAWINGS

FIG. 1 is a flow chart of steps of a first representative embodiment of a process for correcting proximity effects. In the process a reticle is produced by electron-beam drawing. Pattern elements are formed on the reticle while applying dose correction to the electron beam so as to configure the pattern elements on the reticle such that, when the reticle is used to expose a wafer or other substrate, proximity effects are corrected. The process also includes the step of exposing the substrate using the reticle.

FIG. 2 is a flow chart of steps of a second representative embodiment of a process for correcting proximity effects. In the process a reticle is produced by electron-beam drawing. Pattern elements are formed on the reticle while applying dose correction to the electron beam and while applying linewidth correction so as to configure the pattern elements on the reticle such that, when the reticle is used to expose a wafer or other substrate, proximity effects are corrected. The process also includes the step of exposing the substrate using the reticle.

FIG. 3(A) is a plan view of a group of three exemplary pattern elements to be formed on a sensitive substrate while applying an embodiment of the subject proximity-effect correction method.

FIG. 3(B) is a diagram of the respective energy profiles of the pattern elements of FIG. 3(A) immediately downstream of the reticle.

FIGS. 4(A)-4(C) are respective plots of cumulative exposure energy E(x) of a substrate exposed with the three exemplary pattern elements, respectively, shown in FIG. 3(A), using a reticle in which proximity effects are not corrected.

FIGS. 5(A)-5(C) are respective plots of cumulative exposure energy E(x), corresponding to FIGS. 4(A)-4(C), respectively, but wherein the exposures were performed using a reticle produced with dose correction.

FIG. 6 is an elevational schematic diagram showing basic optical and control elements of a charged-particle-beam (CPB) microlithography apparatus with which a divided reticle, produced as described herein, can be exposed.

FIG. 7 is a flow chart of a process for manufacturing a microelectronic device such as an integrated circuit or other semiconductor chip, a liquid-crystal panel, a charge-coupled device (CCD), a thin-film magnetic head, or a micromachine.

### DETAILED DESCRIPTION

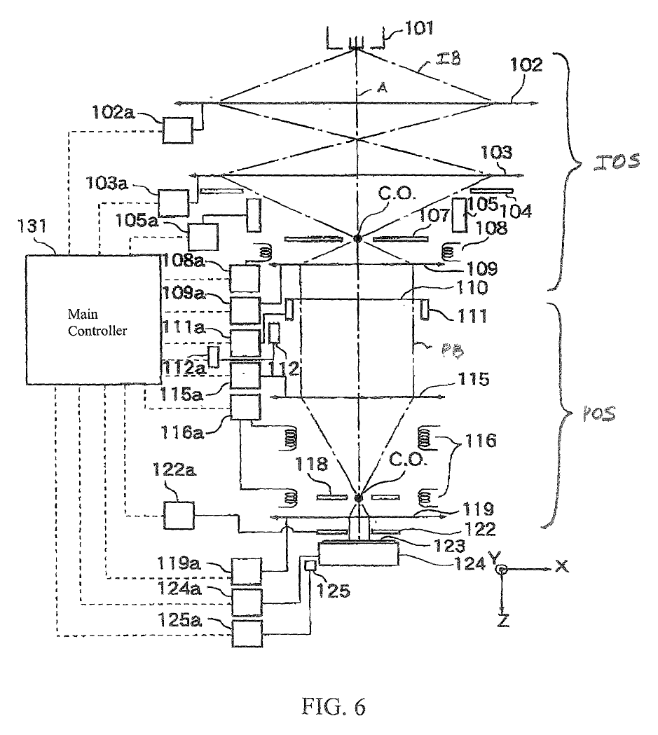

A representative embodiment of a charged-particle-beam (CPB) microlithography system (employing an electron beam as an exemplary charged particle beam) for performing projection exposure of a divided reticle is shown in FIG. 6. Specifically, FIG. 6 shows salient aspects of the CPB-optical system and control system of the CPB microlithography system.

An electron gun 101 is disposed at the extreme upstream end of the system. The electron gun 101 emits an electron beam that propagates in a downstream direction along an optical axis A toward a reticle 110. The electron beam propagating between the electron gun 101 to the reticle 110 is termed the “illumination beam” IB, and the portion of the CPB-optical system situated between the electron gun 101 and the reticle 110 is termed the “illumination-optical system” IOS.

The illuminati on-optical system IOS comprises a two-stage condenser-lens assembly comprising a first condensing lens 102 and a second condensing lens 103. The illumination beam IB passes through the condensing lenses 102, 103 and forms a crossover (C.O.) image at a blanking aperture 107.

The illumination-optical system IOS also comprises a beam-shaping aperture 104 downstream of the second condensing lens 103. The beam-shaping aperture 104 trims outlying portions of the illumination beam IB and thus only transmits a portion of the illumination beam sufficient for illuminating a single subfield or other exposure unit on the reticle 110. On a reticle 110 comprised of multiple subfields, each subfield defines a respective portion of the overall pattern and thus serves as a respective exemplary exposure unit. By way of example, the beam-shaping aperture 104 defines an opening that is square shaped, having dimensions suitable for illuminating a subfield ranging from 0.5 to 5 mm square on the reticle. An image of the opening in the beam-shaping aperture 104 is formed on the reticle by passing the illumination beam IB through an illumination lens 109.

The illumination-optical system IOS also includes a blanking deflector 105 situated downstream of the beam-shaping aperture 104. The blanking deflector 105 is configured to deflect the illumination beam IB as required to direct the beam, during “blanking,” at a portion of the blanking aperture 107 that will block the beam. Thus, during blanking, the illumination beam IB is prevented from reaching the reticle 110.

The illumination-optical system IOS also includes a subfield-selection deflector 108 situated downstream of the blanking aperture 107. The subfield-selection deflector 108 primarily serves to scan (sweep) the illumination beam IB to the left and right in the X direction) to illuminate, in a successive manner, a series of subfields of the reticle 110 that are located within the optical field of the illumination-optical system IOS. The illumination lens 109 is situated downstream of the subfield-selection deflector 108.

Even though only one exposure unit of the reticle 110 is shown in FIG. 6 (on the optical axis A), it will be understood that the reticle 110 actually extends outward within the plane (X-Y plane) perpendicular to the optical axis A and has a large number of exposure units such as subfields. The reticle 110 typically defines an entire die pattern (chip pattern) for forming a particular layer of a microelectronic device formed on a substrate.

The reticle 110 is mounted on a reticle stage 111 that is movable in the X-Y plane to place the various exposure units on the reticle into position for illumination by the illumination beam IB. The reticle stage 111 includes a position detector 112 comprising at least one laser interferometer for accurately determining, in real time, the position of the reticle stage 111 in the X-Y plane.

Between the reticle 110 and a substrate 123 is a “projection-optical system” POS comprising first and second projection lenses 115, 119, respectively, and an imaging-position deflector 116. As the illumination beam IB irradiates a selected exposure unit, portions of the illumination beam are transmitted through the reticle 110 and thus become a “patterned” beam or “imaging” beam PB. The projection-optical system POS is configured to manipulate the patterned beam PB so as to form an image of the irradiated exposure unit on a corresponding location on the substrate 123. So as to be imprintable with the respective images of the exposure units, the upstream-facing surface of the substrate 123 (typically a semiconductor wafer) is coated with a suitable resist. Upon exposure of the resist by the patterned beam PB, an image of the respective pattern portion carried by the patterned beam is imprinted in the resist.

A crossover image C.O. is formed at an axial location at which the axial distance between the reticle 110 and substrate 123 is divided by the demagnification ratio of the projection lenses 115, 119. A contrast aperture 118 is situated at the crossover C.O. The contrast aperture 118 blocks outlying portions of the patterned beam PB comprised of charged particles that were scattered by non-patterned portions of the reticle 110, thereby preventing these scattered particles from reaching the substrate 123.

The substrate 123 is mounted on a wafer chuck (e.g., electrostatic chuck, not shown) on a wafer stage 124. The wafer stage 124 is movable in the X-Y plane so as to ensure that each projected exposure unit is imaged at the correct respective location on the substrate 123. Typically, the various exposure units are exposed successively by synchronously moving the reticle stage 111 and wafer stage 124 in a scanning manner in mutually opposite directions. The position of the wafer stage 124 in the X-Y plane is detected using a position detector 125, which is similar in structure and function to the position detector 112 for the reticle stage 111.

A backscattered-electron (BSE) electron detector 122 is disposed directly upstream of the substrate 123. The BSE detector 122 detects and quantifies electrons backscattered from, for example, a mark on an unexposed location on the substrate 123, on an exposed location on the substrate, or on the wafer stage 124. For instance, the relative positional relationship between the reticle 110 and the substrate 123 can be ascertained by scanning a mark on the substrate 123 with a beam that has passed through a corresponding mark pattern on the reticle 110, and detecting electrons backscattered from the mark on the substrate 123.

The various lenses 102, 103, 109, 115, 119 and deflectors 105, 108, 116 are connected to respective coil-power-supply controllers 102a, 103a, 109a, 115a, 119a and 105a, 108a, 116a, respectively. Each of these controllers is connected to and controlled by a main controller 131. Respective movements and positions of the reticle stage 111 and wafer stage 124 are controlled by the main controller 131 via respective stage controllers 111a, 124a. The stage-position detectors 112, 125 produce and route stage-position data to the main controller 131 via respective interfaces 112a, 125a. To such end, each interface 112a, 125a comprises amplifiers and analog-to-digital (A/D) converters. The main controller 131 also receives data from the BSE detector 122 via an interface 122a.

Based on data input to the main controller 131 as described above, the main controller 131 determines control errors in stage positions and corrects such errors using, for example, the imaging-position deflector 116. As a result of this control, demagnified (reduced) images of the reticle subfields or other exposure units are transferred accurately to respective target positions (“transfer subfields”) on the substrate 123. The various images are positioned so as to be “stitched” together properly on the substrate 123 in the image of the entire die pattern as formed on the substrate 123.

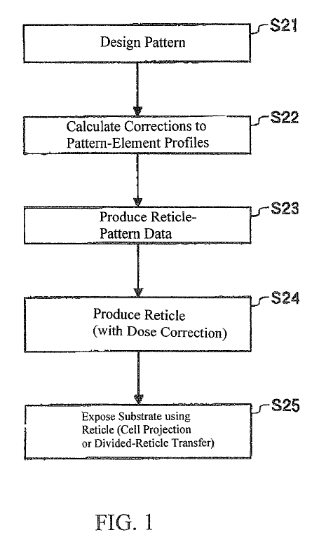

A representative embodiment of a proximity-effect-correction method according to an aspect of the invention is shown in FIG. 1. More specifically, FIG. 1 is a flowchart of certain steps in a process for producing a reticle configured so as to correct proximity effects. The depicted process includes using the reticle for exposing a wafer or other substrate.

In a first step (S21), the pattern to be formed on the sensitive substrate by projection from the reticle is designed. This design step is performed using circuit data for the respective layer of the microelectronic device to be formed on the substrate, and results in a determination of the desired pattern elements and their respective locations as projected onto the substrate. In the next step (S22), calculations are made of specific local resizings of the pattern elements as required to achieve correction of proximity effects when the pattern is projected onto the substrate. Based on the results of these calculations, in the next step (S23), reticle-pattern data are produced for configuring a reticle that defines the pattern and that includes pattern elements locally resized as required to achieve proximity-effect correction when the pattern is projected onto the substrate. Then, the reticle is produced (step S24) based on the data obtained in step S23. During production of the reticle, the “dose” applied by the writing beam is adjusted by variably shaping the beam on the electron-beam-drawing apparatus. Finally (step S25), the reticle is used for transferring the pattern to the sensitive substrate (e.g., semiconductor wafer), typically using a cell projection or divided-reticle type of CPB projection-exposure (microlithography) apparatus.

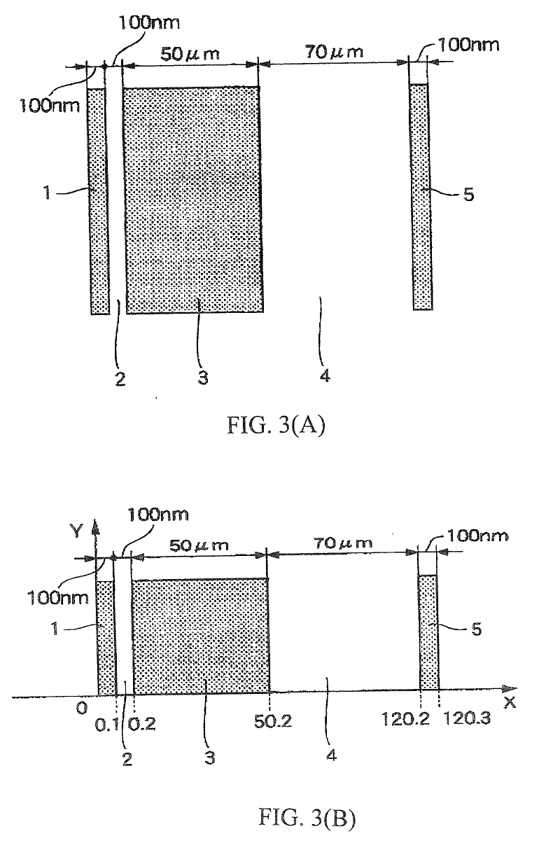

FIG. 3(A) is a plan view of exemplary pattern elements having respective configurations to be formed on a sensitive substrate. The depicted pattern elements are, from left to right in the figure, a narrow line 1, a narrow space 2, a wide line (“pad”) 3, a wide space 4, and a narrow line 5. The narrow lines 1 and 5, and the narrow space 2, are each 100 nm wide. The pad 3 is 50 μm wide. The wide space 4 is 70 μm wide. The scale in the figure is adjusted to make the figure easier to understand.

Consider a situation in which the elements shown in FIG. 3(A) are defined in a reticle subfield measuring 250 μm square, and in which the pattern portion defined this subfield is transferred to a substrate using a divided-reticle type of CPB microlithography apparatus. Consider also that the CPB optical system of the microlithography apparatus has a demagnification ratio of 1/1 (a ratio of 1/1 is used for simplicity of discussion; the usual demagnification ratio is 1/4 or 1/5) and a beam-acceleration voltage of 100 kV.

The energy profile of the FIG. 3(A) subfield immediately downstream of the reticle is shown in FIG. 3(B), in which the ordinate (Y axis) is energy, and the abscissa (X axis) is position in the lateral direction. The energy profile DW(x) immediately downstream of the reticle is a function of x and is expressed as follows:

DW(x)=1.0 for x in the following ranges: 0.0≦x≦0.1, 0.2≦x≦50.2, and 120.2≦x<120.3, and

DW(x)=0.0 for x in the following ranges: x<0.0, 0.1<x<0.2, 50.2<x<120.2, and 120.3<x.

The charged particle beam “carrying” an image of the subfield shown in FIG. 3(A) then is incident on the sensitive substrate, in which the incident charged particles generate backscattered electrons that propagate through the sensitive substrate and produce proximity effects. The cumulative exposure energy E(x) locally received in the sensitive substrate from this scattering is expressed as follows, for example:

E(x)=E_{b}(x)+E_{f}(x)

wherein:

E_{b}(x)=η_{/(}1+η)∫exp[−(x−x′)/σ_{b}²]\sqrt{π}σ_{b}DR(x′)dx′

E_{f}(x)=1/(1+η)∫exp[(−(x−x′)²]/\sqrt{π}σ_{f}DR(x′)dx′

Hence, the cumulative exposure energy at a position x on the sensitive substrate is determined by a convolution of the incident-energy profile DR(x′) (i.e., the energy profile of the patterned beam, carrying the image of the subfield, immediately upstream of the surface of the substrate) and the scattering property exp[−(x−x′)²/σ²], wherein x′ is an integral parameter of convolution and actually denotes the surface positional coordinate. In the expressions above, η is the backscattering coefficient, σ_{b} is the backscattering diameter, and σ_{f} is the forward-scattering diameter. Typical values of these parameters that are used in the calculations (when the charged particle beam is an electron beam accelerated by a voltage of 100 keV) are η=0.4, σ_{b}=31.2 μm, and σ_{f}=7 nm.

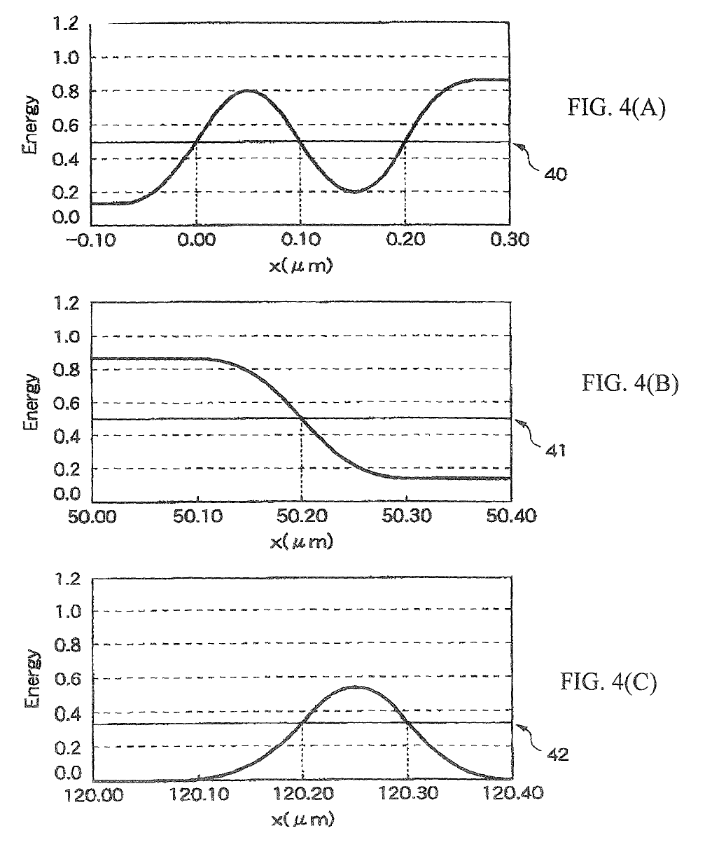

FIGS. 4(A)-4(C) provide graphs of the cumulative-exposure energy E(x) in the sensitive substrate (more particularly the resist layer), taking into account proximity effects. Specifically, FIGS. 4(A), 4(B), and 4(C) show respective profiles of cumulative-exposure energy E(x) within the ranges of x=−0.1 to 0.3 μm (encompassing element 1, space 2, and the left edge of element 3), x=50.0 to 50.4 μm (encompassing the right edge of the element 3), and x=120.0 to 120.4 μm (encompassing the element 5), respectively.

Ideally, assuming no manufacturing errors, local imprinting of a feature resembling a pattern element occurs in the resist layer on the substrate in regions in which an energy threshold of exposure dose has been exceeded. The energy threshold takes into account characteristics of the exposure beam and of the resist. Conversely, no imprinting occurs in regions in which the exposure-energy threshold is not exceeded. The lines 40, 41, 42 in FIGS. 4(A)-4(C), respectively, are respective exposure-energy thresholds established so that the edges of the respective pattern element(s) formed in the respective regions on the substrate will coincide with the respective ideal specified positions on the substrate. As can be seen, the exposure-energy thresholds 40 and 41 are substantially the same, but the threshold 42 is lower. If the threshold 42 in FIG. 4(C) were set substantially the same as the threshold indicated by the lines 40 and 41, then the line element 5 (shown in FIG. 3(A)) would be imprinted on the substrate more narrowly than the specified linewidth for this element. But, if all three exposure-energy thresholds were set substantially at the level indicated by the line 42, then the line element 1 shown in FIG. 3(A) would be wider, the space 2 would be narrower, and the pad 3 would be wider (as imprinted on the substrate) than their respective specifications. As the linewidth of a pattern element changes, the positions of the various edges of the pattern element deviate considerably from their respective specified positions on the substrate.

In the process shown in FIG. 1, the reticle that actually will be used for microlithographic exposure is subjected to dose correction, on the basis of the correction data, at time of reticle production. For example, if the exposure energy threshold is at the level indicated by the lines 40 and 41 in FIGS. 4(A) and 4(B), respectively, then the line element 5 in FIG. 3(A) would have a linewidth, as imprinted on the substrate, that is narrower than specified. In view of this, the exposure dose for this element 5 as imprinted on the substrate is adjusted by defining this pattern element correspondingly larger on the reticle. By so doing, the cumulative energy E(x) in the line element 5 as imaged on the sensitive substrate is above the thresholds 40, 41 shown in FIGS. 4(A) and 4(B), respectively.

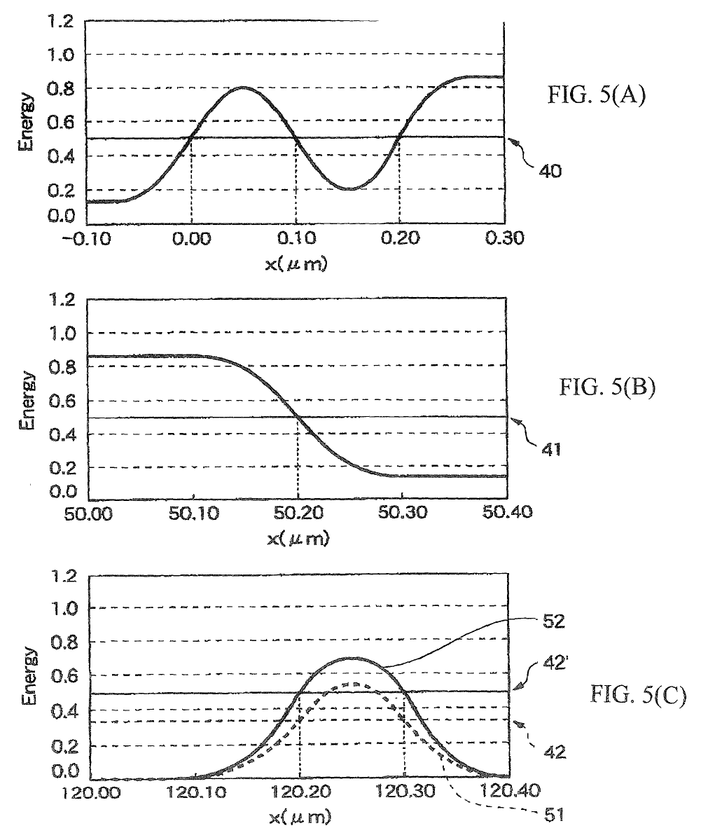

FIGS. 5(A)-5(C) are graphs of the energy profile E(x) obtained when exposure is performed using a reticle on which pattern elements have been altered to achieve dose correction on the substrate. Specifically, FIGS. 5(A), 5(B), and 5(C) depict respective profiles of cumulative exposure energy E(x) within the region of x=−0.1 to 0.3 μm, x=50.0 to 50.4 μm, and x=120.0 to 120.4 μm, respectively. The solid-line plots designate respective energy profiles obtained using a reticle that has undergone dose correction during fabrication of the reticle. The broken-line plot in FIG. 5(C) is the energy profile shown in FIG. 4(C). FIG. 5(C) indicates a threshold 42′ at the same energy magnitude as the thresholds 40, 41 in FIGS. 5(A) and 5(B), respectively.

As shown in FIG. 5(C), the maximum cumulative exposure energy E(x) in the line element 5 obtained on the sensitive substrate with a “dose-corrected” reticle is greater than in the line element 5 under conditions as shown in FIG. 4(C) (using a reticle on which the element is not dose-corrected). At the threshold 42′, the precorrection energy profile 51 exceeds the threshold over a range of x that is about half the desired range. In contrast, the post-correction energy profile 52 exceeds the threshold 42′ over a desired range of x=120.2 to 120.3 μm. Thus, the desired pattern-element profile is obtained on the substrate by adjusting the dose used to define the corresponding pattern element on the reticle during reticle production.

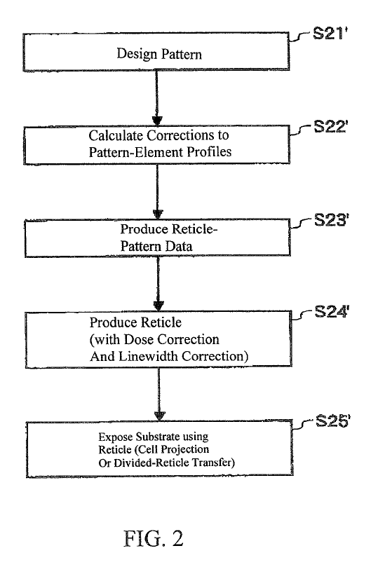

Proximity-effect correction according to a second representative embodiment is depicted in FIG. 2, which is a flowchart of certain steps of the method.

In a first step (S21′), the pattern to be formed on the sensitive substrate by projection from the reticle is designed. This design step is performed using circuit data for the respective layer of the microelectronic device to be formed on the substrate, and results in a determination of the desired pattern elements and their respective locations as projected onto the substrate. In the next step (S22′), calculations are made of specific corrections to pattern-element profiles as required to achieve correction of proximity effects when the pattern is projected onto the substrate. Based on the results of these calculations, in the next step (S23′), reticle-pattern data are produced for configuring a reticle that defines the pattern with pattern elements having corrected profiles. Then, the reticle is produced (step S24′) based on the data obtained in step S23′. During production of the reticle, the “dose” applied by the writing beam is adjusted as required (e.g., by variably shaping the beam of the electron-beam-drawing apparatus) to correct the pattern-element linewidths as formed on the reticle by the beam. Correction of respective linewidths of pattern elements as formed on the substrate involves not only increasing or decreasing the respective exposure doses of the pattern elements as formed on the substrate but also correcting the respective widths of the pattern elements as defined on the reticle (local resizing). Finally (step S25′), the reticle is used for transferring the pattern to the sensitive substrate (e.g., resist-coated semiconductor wafer), typically using a cell projection or divided-reticle type of CPB projection-exposure (microlithography) apparatus.

In this example, the reticle that is actually used for microlithography is subjected to both dose correction and linewidth correction at time of reticle fabrication, based on the data in FIGS. 4(A)-4(C). First, linewidth corrections are performed at an accuracy of 10 nm on the basis of the data in FIGS. 4(A)-4(C). The reticle then is subjected to high-precision dose correction. This combined method allows the overall correction of the reticle to be made at an even higher accuracy than the first representative embodiment.

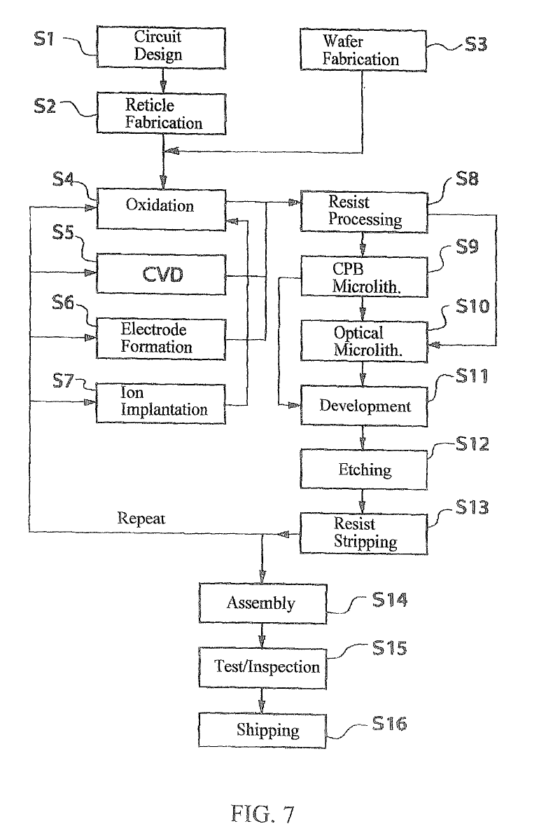

FIG. 7 is a flow chart of steps in a process for manufacturing a microelectronic device such as a semiconductor “chip” (e.g., integrated circuit or LSI device), a display panel (e.g., liquid-crystal panel), a charge-coupled device (CCD), a thin-film magnetic head, or a micromachine, for example. Steps S1-S3 are “pre-process” steps. In step S1 (circuit design) the circuit for the device is designed. In step S2 (reticle fabrication) a reticle for the circuit is manufactured. In this step, improper beam focus that otherwise would be caused by proximity effects or space-charge effects can be corrected by subjecting the pattern, as defined on the reticle, to local resizing and other modifications. In step S3 (wafer fabrication) a wafer or other suitable substrate is manufactured from a material such as silicon.

Steps S14-S16 occur after wafer processing and hence are termed “postprocess” steps. Step S14 (assembly) is an assembly step in which the wafer that has been passed through steps S4-S13 is formed into chips. This step can include, for example, assembling the devices (dicing and bonding) and packaging (encapsulation of individual chips). Step S15 (test/inspection) is an inspection step in which any of various operability and qualification tests of the devices produced in step S14 are conducted. Afterward, devices that successfully pass step S15 are finished, packaged, and shipped (step S16).

Steps S4-S13 are directed to wafer-processing steps that include microlithography, etching, and other steps. Step S4 (oxidation) is an oxidation step in which the surface of the wafer is oxidized. Step S5 (CVD) involves chemical vapor deposition (CVD) for forming an insulating film on the wafer surface. Step S6 (electrode formation) is an electrode-forming step for forming electrodes on the surface of the wafer (typically by vapor deposition). Step S7 (ion implantation) is an ion-implantation step in which ions (e.g., of dopant) are implanted into the wafer. Step S8 (resist processing) involves application of a resist (exposure-sensitive material) to the wafer. Step S9 (CPB microlithography) involves exposing the wafer with the circuit pattern on the reticle by means of CPB microlithography apparatus and methods using the reticle produced in step S2. The exposure methods discussed above are used during this step. In step S10 (optical microlithography), an optical microlithography reticle produced in step S2 is used to expose and print the wafer with the reticle pattern by means of an optical stepper or the like. Before or during either of these microlithography steps, corrections of proximity effects can be made. (The proximity-effect correction methods discussed above are utilized in step S9.) Step S11 (development) involves developing the exposed resist on the wafer. Step S12 (etching) involves etching the wafer to selectively remove material from areas where developed resist is absent. Step S13 (resist stripping) involves resist separation, in which remaining resist on the wafer is removed after the etching step. By repeating steps S4-S13 as required, circuit patterns as defined by successive reticles are formed superposedly on the wafer.

The CPB microlithography methods described above are in the context of using a segmented (divided) reticle and use of an electron beam as the lithographic energy beam. Alternatively, for example, the methods can be used with a cell-projection system and/or an ion-beam microlithography system.

Whereas the invention has been described in connection with several representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. In a charged-particle-beam (CPB) microlithography method in which a device pattern, to be transferred onto a specific area of a sensitive substrate, is defined on a reticle that is subsequently illuminated with a charged-particle illumination beam to form a patterned beam that is directed at the sensitive substrate so as to imprint a corresponding region of the substrate with the pattern, a method for correcting errors in pattern elements, as imprinted on the substrate, caused by proximity effects, the proximity-effect correction method comprising:
in performing a local resizing of a pattern element on the reticle, changing a linewidth of the pattern element, as defined on the reticle, by correspondingly changing an energy dose of an electron beam used to draw the pattern element on the reticle so as to change the linewidth from its initial design value.

2. In a charged-particle-beam (CPB) microlithography method in which a device pattern, to be transferred onto a specific area of a sensitive substrate, is formed on a reticle that is subsequently illuminated with a charged-particle illumination beam to form a patterned beam that is directed at the sensitive substrate so as to imprint a corresponding region of the substrate with the pattern, a method for correcting errors in pattern elements, as imprinted on the substrate, caused by proximity effects, the proximity-effect correction method comprising:
in performing a local resizing of a pattern element on the reticle, changing a linewidth of the pattern element, as defined on the reticle, by correspondingly changing (i) a drawn linewidth of the pattern element, and (ii) an energy dose of an electron beam used to draw the pattern element on the reticle so as to change the linewidth from its initial design value.

3. A method for producing a reticle for use in transferring a pattern, defined by the reticle, from the reticle to a substrate by charged-particle-beam microlithography, the method comprising:
in a design for a reticle pattern comprising pattern elements to be transferred to the substrate, calculating local-resizing corrections to profiles of the pattern elements, to be defined on the reticle, so as to configure the pattern-element profiles for correcting proximity effects that otherwise would be manifest on the pattern elements when projected onto the substrate;
from the calculated corrections, obtaining corrected reticle-pattern data; and
forming the pattern elements on a reticle by drawing the pattern elements using an electron beam that is variably shaped as required to impart respective changes, according to the corrected reticle-pattern data, in a dose of the electron beam on the reticle, the changes in dose imparting corresponding changes in linewidths of the pattern elements, as defined on the reticle, sufficiently to reduce proximity effects acting on the pattern elements when the pattern is transferred to the substrate.

4. The method of claim 3, further comprising the step, when forming the pattern elements on the reticle, of changing the drawn line width of the pattern elements.

5. A method for producing a reticle for use in transferring a pattern, defined by the reticle, from the reticle to a substrate by charged-particle-beam microlithography, the method comprising:
in a design for a reticle pattern comprising pattern elements to be transferred to the substrate, calculating corrections to profiles of the pattern elements, to be defined on the reticle, so as to configure the pattern-element profiles for correcting proximity effects that otherwise would be manifest on the pattern elements when projected onto the substrate;
from the calculated corrections, obtaining corrected reticle-pattern data;
according to the corrected reticle-pattern data, performing local resizing of the pattern elements; and
forming the locally resized pattern elements on a reticle by drawing the pattern elements using an electron beam as required to impart respective changes, according to the corrected reticle-pattern data, in a dose of the electron beam on the reticle, the changes in dose imparting corresponding changes in linewidths of the locally resized pattern elements, as defined on the reticle, sufficiently to reduce proximity effects acting on the pattern elements when the pattern is transferred to the substrate.

6. The method of claim 5, further comprising the step, when forming the pattern elements on the reticle, of changing the drawn linewidth of the pattern elements.

7. A reticle, produced according to the method recited in claim 3.

8. A reticle, produced according to the process recited in claim 5.

9. A reticle defining a device pattern to be transferred onto a specific area of a sensitive substrate, comprising:
a reticle substrate; and
a pattern defined on the reticle substrate, the pattern including a pattern element that is locally resized relative to a design specification for the pattern element, the locally resized pattern element having a linewidth that is corrected so as to reduce a proximity effect that otherwise would occur if the pattern element were exposed onto a sensitive substrate without the corrected linewidth, the linewidth being corrected on the reticle by varying a dose of an electron beam used to write the pattern element on the reticle substrate.

10. A reticle defining a device pattern to be transferred onto a specific area of a sensitive substrate, comprising:
a reticle substrate; and
a pattern defined on the reticle substrate, the pattern including a pattern element that is locally resized relative to a design specification for the pattern element, the locally resized pattern element having a linewidth that is corrected so as to reduce a proximity effect that otherwise would occur if the pattern element were exposed onto a sensitive substrate without the corrected linewidth, the linewidth being corrected on the reticle by varying a dose of an electron beam used to write the pattern element on the reticle substrate and by changing the linewidth as drawn on the reticle substrate.

11. A method for manufacturing a microelectronic device, comprising the steps of:
providing a reticle as recited in claim 9; and
microlithographically transferring the pattern, defined on the reticle, to a sensitive substrate using a charged particle beam.

12. A method for manufacturing a microelectronic device, comprising the steps of:
providing a reticle as recited in claim 10; and
microlithographically transferring the pattern, defined on the reticle, to a sensitive substrate using a charged particle beam.
